(19) United States
(12) Patent Application Publication
(10) Pub. No.: US 2025/0187532 A1
(43) Pub. Date: Jun. 12, 2025

(54) AUTOMATIC TURN SIGNAL INDICATION BASED ON PROBABILISTIC MANEUVER PREDICTION

(71) Applicant: GM GLOBAL TECHNOLOGY OPERATIONS LLC, Detroit, MI (US)

(72) Inventors: Vaibhav J. LAWAND, Northville, MI (US); Steven J. VANCE, Farmington Hills, MI (US); Mohammadali SHAHRIARI, Markham (CA); Mehdi ABROSHAN, Waterloo (CA); Hassan ASKARI, Thornhill (CA); Khizar Ahmad QURESHI, Pickering (CA); Puneet BAGGA, Etobicoke (CA)

(21) Appl. No.: 18/535,163

(22) Filed: Dec. 11, 2023

(51) Int. Cl. B60Q 1/34

(52) U.S. Cl. CPC B60Q 1/34; B60Q 2400/20

(57) ABSTRACT

A turn signal indication system includes: at least one turn signal indicator; an adaptive maneuver prediction module configured to predict that a host vehicle is to make a turn or change lanes; an activation decision module configured to, based on the prediction, determine whether the host vehicle is to make a left turn, make a right turn, change to a left lane, or change to a right lane; and a signal indication module configured to automatically activate the at least one turn signal indicator based on the determination of whether the host vehicle is to make a left turn, make a right turn, change to a left lane, or change to a right lane.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to vehicle turn signal systems.

A host vehicle can include various systems for assisting a driver, for performing autonomous operations, and/or for indicating to a vehicle occupant information regarding an environment of the host vehicle. For example, a host system may include a navigation system that provides map information indicating lane boundaries, street locations, speed limits, geographical locations of selected destinations, etc. The host system may provide the driver with instructions for driving to a selected destination and/or may perform autonomous operations such as braking, steering and accelerating operations to drive the vehicle to the destination based on the map information.

As another example, a host vehicle can include object detection and collision warning systems for detecting impending objects and performing countermeasures and/or taking evasive action to prevent a collision. The vehicle can include various sensors for detecting objects, such as other vehicles, pedestrians, cyclists, etc. A controller determines locations of the objects relative to the host vehicle and trajectories of the objects and the host vehicle. If it is determined that the host vehicle is likely to collide with one of the objects, one or more warning signals may be generated to indicate to the driver and/or the object of concern of the potential collision. The controller may also or alternatively perform one or more other countermeasures (e.g., apply brakes to decelerate the host vehicle, change a steering angle of the host vehicle, etc.) to prevent a collision.

### SUMMARY

A turn signal indication system is disclosed and includes: at least one turn signal indicator; an adaptive maneuver prediction module configured to predict that a host vehicle is to make a turn or change lanes; an activation decision module configured to, based on the prediction, determine whether the host vehicle is to make a left turn, make a right turn, change to a left lane, or change to a right lane; and a signal indication module configured to automatically activate the at least one turn signal indicator based on the determination of whether the host vehicle is to make a left turn, make a right turn, change to a left lane, or change to a right lane.

In other features, the adaptive maneuver prediction module is configured to: determine a first probability value indicative of a probability of a left turn or a change to a left lane based on at least one of i) historical and statistical data for left turns and changes to left lanes, and ii) sensory data for left turns and changes to left lanes; determine a second probability value indicative of a probability of a right turn or a change to a right lane based on at least one of i) historical and statistical data for right turns and changes to right lanes, and ii) sensory data for right turns and changes to right lanes; predict the host vehicle is to make a left turn or change to a left lane based on the first probability value; and predict the host vehicle is to make a right turn or change to a right lane based on the second probability value.

In other features, the turn signal indication system further includes a turn signal module configured to determine whether to inhibit automatic turn signal activation based on whether a driver override flag has been set.

In other features, the turn signal indication system further includes a turn signal module configured to adjust timing of automatic turn signal activation based on a received user input, where the received user input is at least one of indicative and directly related to an amount of time prior to a turn to activate the at least one turn signal indicator.

In other features, the at least one turn signal indicator has a different color when automatically triggered than when manually triggered.

In other features, the at least one turn signal indicator has a different audible pattern when automatically triggered than when manually triggered.

In other features, the turn signal indication system further includes a turn signal module configured to determine a speed of the host vehicle and, based on the speed, to inhibit activation of the at least one turn signal indicator.

In other features, the turn signal indication system further includes a driver signal validation module configured to detect manual triggering of the at least one turn signal indicator by a driver, and to determine whether the manually triggered at least one turn signal indicator matches the prediction. The signal indication module is configured to generate a message for the driver indicating to the driver that an incorrect turn signal indicator may have been selected.

In other features, the turn signal indication system further includes a driver signal validation module configured to detect manual triggering of the at least one turn signal indicator by a driver, and to determine whether the manually triggered at least one turn signal indicator matches the prediction. The signal indication module is configured to maintain activation of the manually triggered at least one turn signal indicator in response to the manually triggered at least one turn signal indicator matching the prediction.

In other features, the turn signal indication system further includes a prediction error module configured to calculate a prediction error value for the prediction, and to update a prediction model used to make the prediction based on the prediction error value.

In other features, the turn signal indication system further includes a driver signal validation module configured to detect manual triggering of the at least one turn signal indicator by a driver, and to determine whether the manually triggered at least one turn signal indicator matches the prediction. The prediction error module is configured to calculate the prediction error value based on whether the manually triggered at least one turn signal indicator matches the prediction.

In other features, a method for automatically activating at least one turn signal indicator is disclosed. The method includes: predicting that a host vehicle is to make a turn or change lanes; based on the prediction, determining whether the host vehicle is to make a left turn, make a right turn, change to a left lane, or change to a right lane; and automatically activating the at least one turn signal indicator based on the determination of whether the host vehicle is to make a left turn, make a right turn, change to a left lane, or change to a right lane.

In other features, the method further includes: determining a first probability value indicative of a probability of a left turn or a change to a left lane based on at least one of i) historical and statistical data for left turns and changes to left lanes, and ii) sensory data for left turns and changes to left lanes; determining a second probability value indicative of a probability of a right turn or a change to a right lane based on at least one of i) historical and statistical data for right turns and changes to right lanes, and ii) sensory data for right turns and changes to right lanes; predicting the host vehicle is to make a left turn or change to a left lane based on the first probability value; and predicting the host vehicle is to make a right turn or change to a right lane based on the first probability value.

In other features, the method further includes determining whether to inhibit automatic turn signal activation based on whether a driver override flag has been set.

In other features, the method further includes adjusting timing of automatic turn signal activation based on a received user input, where the received user input is at least one of indicative and directly related to an amount of time prior to a turn to activate the at least one turn signal indicator.

In other features, the at least one turn signal indicator has a different color when automatically triggered than when manually triggered.

In other features, the at least one turn signal indicator has a different audible pattern when automatically triggered than when manually triggered.

In other features, the method further includes determining a speed of the host vehicle and, based on the speed, inhibit activation of the at least one turn signal indicator.

In other features, the method further includes: detecting manual triggering of the at least one turn signal indicator by a driver; determining whether the manually triggered at least one turn signal indicator matches the prediction; generating a message for the driver indicating to the driver that an incorrect turn signal indicator may have been selected; and maintaining activation of the manually triggered at least one turn signal indicator in response to the manually triggered at least one turn signal indicator matching the prediction.

In other features, the method further includes: calculating a prediction error value for the prediction, and update a prediction model used to make the prediction based on the prediction error value; detecting manual triggering of the at least one turn signal indicator by a driver, and determine whether the manually triggered at least one turn signal indicator matches the prediction; and calculating the prediction error value based on whether the manually triggered at least one turn signal indicator matches the prediction.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example host vehicle including an example automatic turn signal (ATS) system including a vehicle control module implementing an ATS module in accordance with the present disclosure;

FIG. 2 is a functional block diagram of the vehicle control module and ATS module of FIG. 1 in accordance with an embodiment of the present disclosure;

FIGS. 3A-3B (collectively FIG. 3) illustrates an example ATS method in accordance with the present disclosure;

FIG. 4 is an overhead view of a host vehicle that is to make a left turn and operating according to the principles described herein;

FIG. 5 is an overhead view of a host vehicle before a stop sign and to make a right turn and operating according to the principles described herein;

FIG. 6 is an overhead view of a host vehicle to make one of multiple possible right turns and operating according to the principles described herein;

FIG. 7 is an overhead view of a host vehicle to change lanes and operating according to the principles described herein; and

FIG. 8 is a diagram including an overhead view of a host vehicle to make a left turn and operating according to the principles described herein and timing plots illustrating quick automatic triggering of turn signal operation.

In the drawings, reference numbers may be reused to identify similar and/or identical elements.

### DETAILED DESCRIPTION

A high percentage of drivers tend not to use turn signals when making turns and when changing lanes. Neglecting to use a turn signal to indicate to other drivers that a host vehicle is about to make a turn or change lanes can result in an accident. Errors in selecting a turn signal (i.e., a left turn signal or a right turn signal) can also occur. For example, a driver may intend to make a left turn or change lanes to a left lane and accidentally turn on a right turn signal.

The examples set forth herein include an ATS system for automatically turning on turn signals. This may occur i) prior to and/or during turns by a host vehicle, and/or ii) prior to and/or when a host vehicle is changing lanes. The ATS system aids vehicle operators in turning on turn signal indicators (e.g., interior and exterior turn signal indicator lights) even when the vehicle operators do not manually turn on the turn signal indicators. Examples disclosed herein include implementation of a probabilistic maneuver prediction algorithm, which is used to detect driver intent to make a turn or change lanes. These predictions occur prior to or at a beginning of maneuvers, in for example, less than 1 second and the turn signal indicators are turned on automatically. The turn signals are turned on when certain conditions are satisfied, as further described below. By increasing use of turn signal indicators to better notify nearby vehicles, pedestrians, and/or cyclists, etc. of a host vehicle driver's intent, safety is improved for the host vehicle drivers as well as the nearby drivers, pedestrians, and/or cyclists.

The examples herein include a turn signal triggering method that utilizes the output of maneuver prediction and enables the appropriate turn signal indicator for the vehicle. This may be implemented using a human machine interface (HMI) such as one or more displays as described below to indicate to the driver that a left or right turn signal is activated.

In an embodiment, a driver override function is implemented that allows a driver to delay and/or prevent turn signal activation even when the ATS system has determined that a turn signal should be activated. This may be based on driver reaction time when reacting to automatic activation of a turn signal indicator.

In another embodiment, an HMI method of providing turn signal options to a driver is implemented. The options may include whether to trigger or not to trigger ON one or more turn signals. This may include displaying the options on one or more displays to a driver and allowing the driver to select one of the options. The options may be provided ahead of a turn. The timing of when the options are presented to the driver can be set by the driver as part of a customizable and configurable ATS system screen. The driver, prior to driving, may open the screen and set ATS features, such as ATS timing, illumination patterns, audible patterns, etc.

In another embodiment, audible alerts and interior facing turn signal indications used when a turn signal is automatically activated are different than audible alerts and interior facing turn signal indications made when a turn signal is manually activated by a driver. For example, a click-clack pattern and/or colors of turn signal indicators may be different. This indicates to the driver that the turn signal was automatically activated and the driver did not turn on the turn signal.

In another embodiment, the ATS system operates in a teen mode or a fleet mode. The teen mode is implemented when a teenager or other beginner driver is driving the vehicle and may be enabled by, for example, a parent and/or owner of the host vehicle. A fleet mode is implemented by a business that has multiple vehicles, which may be monitored by a fleet manager. During the teen mode and the fleet mode, certain safety features are automatically enabled including ATS operation for automatically turning on turn signals. In this mode, a driver may not be able to override and prevent activation of a turn signal. The driver may however be able to turn off the turn signal after the turn signal has been activated for a set period of time (e.g., 5 seconds). In an embodiment, the teen mode and fleet mode forces auto indication to improve driving safety. As another example of a safety feature that may be automatically enabled when in the teen mode and/or the fleet mode is collision imminent braking, where the vehicle control module automatically applies the brakes to avoid a potential collision.

In yet another embodiment, the automatic indication of a driver about to make a turn is used for collision avoidance purposes. This may include a vehicle control module performing an assisted evasive maneuver (e.g., autonomously steer the vehicle) to avoid a collision with an impending object.

The examples include storing driver behavior data including when a driver activates turn signals, timing of when the driver activates turn signals (or distances between host vehicle and turns when turn signals are activated), when a driver makes turns and does not activate turn signals, locations where turn signals are activated and not activated, vehicle speeds when turn signals are activated and not activated, etc. This allows the ATS system and an ATS module thereof to i) learn driver behavior and preferences for effective activation of turn signals, ii) signal to driver to suggest turning on turn signals, and iii) provide signals to driver when the host vehicle made a turn and the driver did not turn on the turn signals.

The collected driver behavior data may be uploaded to a cloud-based network and/or be used to make statistical determinations. For example, a vehicle control module and/or the ATS module may determine which scenarios a driver is most likely to need assistance in turning on turn signal indicators. The vehicle control module and/or the ATS module may operate initially in a learn mode including collecting and analyzing data. The vehicle control module and/or the ATS module may then, based on the learned information, perform operations to aid a driver in turning on turn signal indicators. In an embodiment, the vehicle control module and/or the ATS module indicates to a driver how many turn signal indications the driver missed and whether the ATS system should automatically activate turn signals in general and/or in the locations where the turn signals were missed.

The vehicle control module and/or the ATS module may automatically activate turn signal indicators based on a driving scenario (or situation) aligned with driver behavior. For example, automatic turn signal activation may be inhibited when a host vehicle is driving in a parking lot and/or when driving at speeds below a predetermined speed (e.g., less than 10 miles per hour (mph)). As another example, geofencing may be implemented, such that automatic turn signal activation is inhibited in certain geographical regions and/or locations, such as in a parking lot. Geofencing may also be implemented to, for example, determine if a host vehicle is on a highway and is about to change lanes as a result of a small change in steering angle.

In an embodiment, the vehicle control module and/or the ATS module transmits driver behavioral data and/or data indicating when turn signals have and have not been activated to an insurance company. This allows the insurance company to correlate accidents with instances when turn signals have not been used versus accidents when turn signals have been used.

The examples herein are implemented in a manner not to discourage a driver from manually triggering turn signals, but rather are performed to activate turn signals when a driver forgets. The operations are performed such that a driver does not become dependent on the disclosed ATS system. As an example and in an embodiment, if a driver is repeatedly late in turning on turn signal indicators and/or repeatedly forgets to turn on turn signal indicators, then automatic activation is inhibited. When inhibited, the ATS system or the ATS module thereof generates a message to the driver indicating to the driver i) prior to a turn and/or prior to a change lane event to turn on a turn signal indicator, and ii) during or subsequent to making the turn or switching lanes, that he or she forgot to turn on a turn signal indicator. The message may indicate how many times the driver has been late and/or forgot to trigger a turn signal indicator in a last predetermined number of turns and/or changes in lanes. The message may indicate this in terms of a percentage of misses of the last predetermined number of turns and/or changes in lanes.

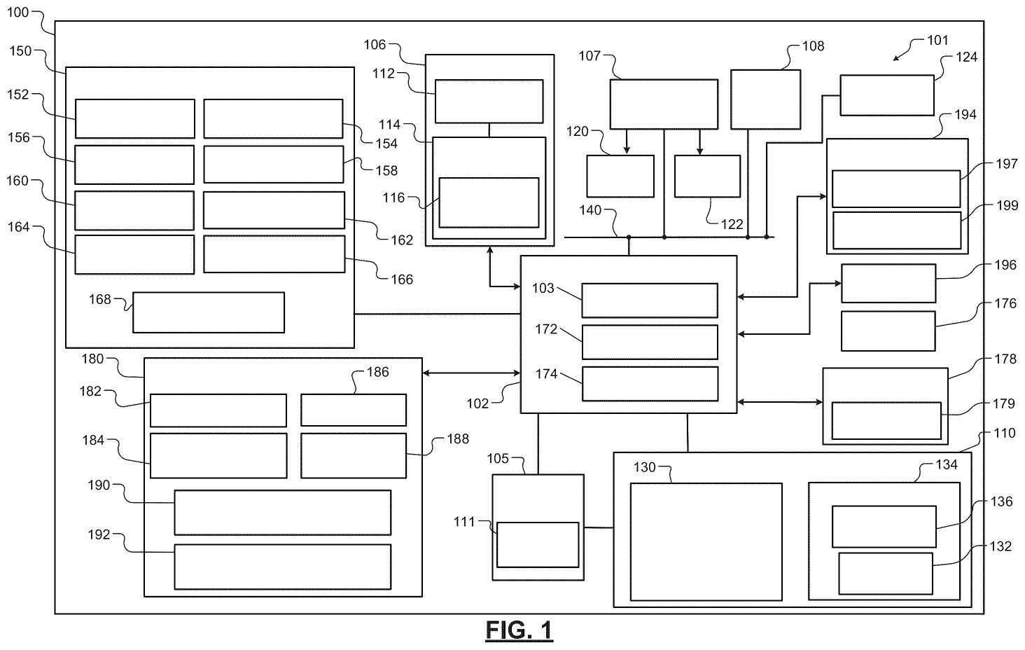

FIG. 1 shows a host vehicle 100 including an example ATS system 101. The ATS system 101 includes a vehicle control module 102 implementing an ATS module 103. The ATS module 103 as described further below performs automatic turn signal indication operations including when to automatically activate turn signal indicators and when certain conditions are satisfied automatically activating turn signal indicators. The ATS module predicts when the host vehicle is about to turn and/or change lanes, monitors driver activity, and when appropriate, automatically activates turn signal indicators ahead of, at a beginning of, and/or during turns and/or changes in lanes. The vehicle control module 102 and/or the ATS module 103 may perform various operations based on interaction with a driver of the host vehicle 100. The vehicle control module 102 may perform autonomous operations based on the interaction including responses received from the driver.

The vehicle 100 and/or the ATS system 101 further includes one or more power sources 105, a telematics module 106, an infotainment module 107, other control modules 108 and a propulsion system 110. The vehicle control module 102 may control operation of the vehicle 100 and the modules 103, 106, 107, 108 and the propulsion system 110. The power sources 105 may include one or more battery packs, a generator, a converter, a control circuit, terminals for high and low voltage loads, etc., as well as one or more battery sensors 111 for detecting states of the power sources 105 including voltages, current levels, states of charge, etc.

The telematics module 106 provides wireless communication services within the vehicle 100 and wirelessly communicates with service providers, back offices, central offices, cloud-based networks, businesses, and devices external to the vehicle 100. The telematics module 106 may support Wi-Fi®, Bluetooth®, Bluetooth Low Energy (BLE), near-field communication (NFC), cellular, legacy (LG) transmission control protocol (TCP), long-term evolution (LTE), and/or other wireless communication and/or operate according to Wi-Fi®, Bluetooth®, BLE, NFC, cellular, and/or other wireless communication protocols. The telematics module 106 may include one or more transceivers 112 and a navigation module 114 with a global positioning system (GPS) and GNSS (or Global Navigation Satellite System) receiver 116. The transceivers 112 wirelessly communicate with network devices internal and external to the vehicle 100 including cloud-based network devices, central stations, back offices, and portable network devices. The transceivers 112 may perform pattern recognition, channel addressing, channel access control, and filtering operations.

The navigation module 114 executes a navigation application to provide navigation services. The navigation services may include location identification services to identify where the vehicle 100 is located. The navigation services may also include guiding a driver and/or directing the vehicle 100 to a selected location. The navigation module 114 may communicate with a central station to collect map information indicating levels of traffic, transportation object identification and locations (e.g., locations and types of signs), path information, locations of turns, lane identification, ramp locations, etc. As an example, if the vehicle 100 is an autonomous vehicle, the navigation module 114 may direct the vehicle control module 102 along a selected route to a selected destination. The GPS and GNSS receiver 116 may provide vehicle velocity and/or direction (or heading) of the vehicle 100 and other vehicles and objects (e.g., pedestrians and cyclists) and/or global clock timing information.

The infotainment module 107 may include and/or be connected to an audio system 122 and/or a video system including one or more displays (one display 120 is shown). The display 120 and audio system 122 may be part of a human machine interface. The displays may include cluster and/or center console displays, head-up displays, etc. Haptic devices 124 (e.g., steering wheel and/or seat vibration devices) may be used in addition to the displays and the audio system 122 to interact with a vehicle occupant such as a driver or passenger. This interaction is further described below and may include indicating to a driver when to activate a turn signal, when a turn signal is missed at a turn, how many times a turn signal incident is missed, whether an incorrect turn signal is and/or was activated, etc. A turn signal incident is missed when the ATS module 103 determines that a turn signal should have been activated and the driver did not activate the turn signal indicator. The interaction may also include providing a driver with a customization screen on the display 120 to allow the driver to set turn signal related parameters, such as turn signal activation sensitivity, how early a turn signal is activated prior to a turn, a distance prior to a turn when a turn signal is too be activated, whether ATS operation is enabled, etc. Messages may be displayed, audibly played out, and/or indicated via the display 120, the audio system 122, the haptic devices 124, and/or via one or more other output devices.

The infotainment module 107 may provide various proactive messages and information. The infotainment module 107 may be used to indicate that: a turn signal indicator should be activated; the ATS system 101 is about to activate a turn signal indicator; the ATS system 101 has activated a turn signal; a turn signal incident was missed and the ATS system 101 activated a turn signal; etc. The infotainment module 107 may guide a vehicle operator to a certain location, guide a vehicle operator around a turn, guide a vehicle operator to change lanes, and/or display other information.

The propulsion system 110 may include one or more torque sources, such as one or more motors and/or one or more engines (e.g., internal combustion engines). In the example shown in FIG. 1, the vehicle 100 includes an engine 130 and one or more motors 132. The torque sources are independently controlled. The propulsion system 110 includes a motor control system 134 that includes the one or more motors 132 and a motor control module 136 that may control operation of the one or more motors 132 based on signals from the vehicle control module 102.

The modules 102, 103, 107, 108 may communicate with each other via one or more buses 140, such as a controller area network (CAN) bus and/or other suitable interface. The vehicle control module 102 may control operation of vehicle modules, devices and systems based on feedback from sensors 150.

The sensors 150 may include exterior sensors, interior sensors, vehicle state sensors, and other sensors. For example, the sensors 150 may include, as shown, radar and/or lidar sensors 152, exterior imaging and audio devices (e.g., cameras and microphone or microphone array) 154, interior imaging devices 156, interior microphone or microphone array 158, velocity sensors (e.g., longitudinal and lateral velocity sensors) 160, acceleration sensors (e.g., longitudinal and lateral acceleration sensors) 162, a yaw rate sensor 164, an inertial measurement sensor 166, and other sensors 168. The other sensors 168 may include wheel angle sensors.

The exterior sensors may be used to detect objects external to the vehicle 100 and/or in a path of the vehicle 100. The interior sensors may include interior imaging sensors (e.g., cameras) and a microphone or microphone array, which may be used to monitor physical activity, eye movement, and/or gaze direction of a driver and/or to interact with the driver. The interior sensors may also be used to detect gestures made by the driver, detect orientation of a body of the driver, detect speech of the driver, etc. This monitoring is useful in determining whether the driver is looking for a turn, a street to turn at, a location to change lanes, etc.

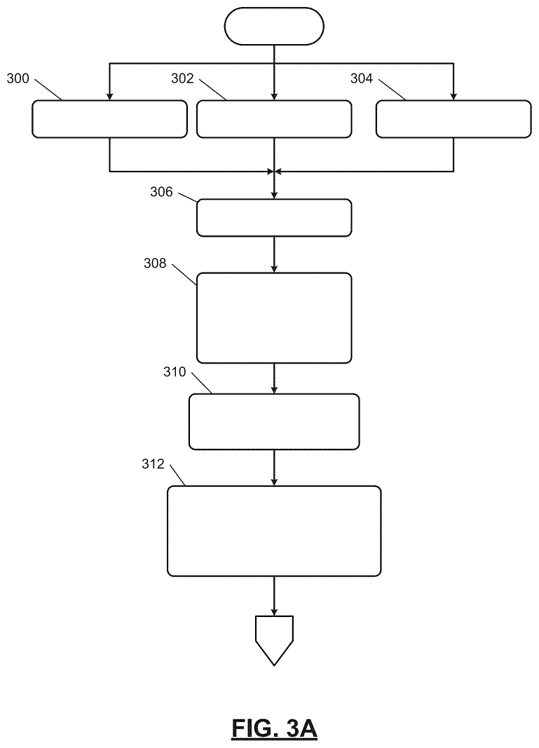

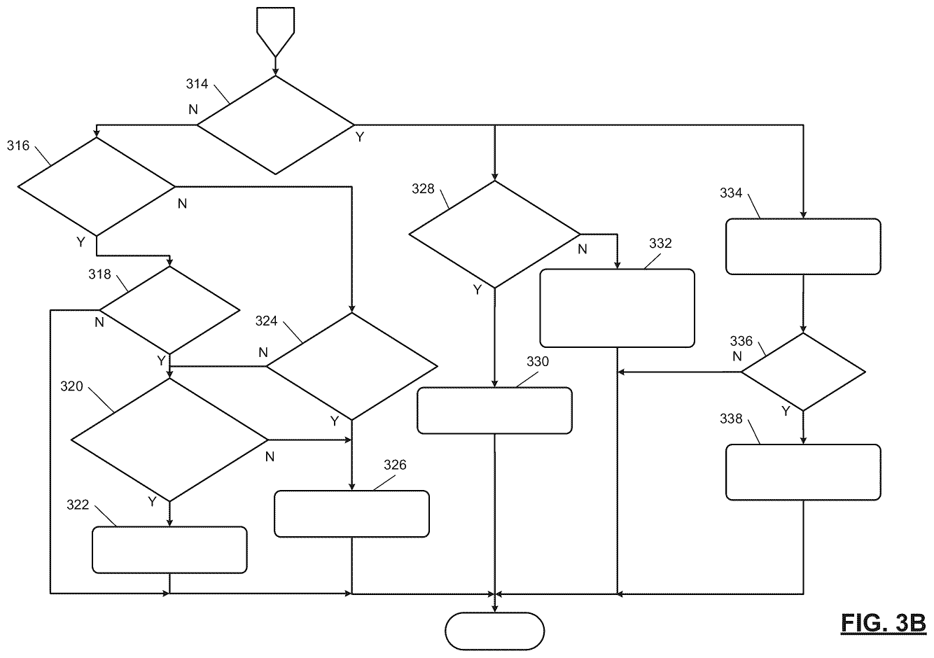

The vehicle control module 102 may also include a mode selection module 172 and a parameter adjustment module 174. The mode selection module 172 may select a vehicle operating mode including an ATS mode, a teen mode, and a fleet mode. The ATS mode may refer to when ATS operation (i.e., automatic activation of turn signal indicators is permitted) is enabled. In FIG. 3 ATS operations are implemented. At least some of the operations may be implemented when the vehicle control module 102 is not operating in the ATS mode.

The parameter adjustment module 174 may be used to adjust parameters of the vehicle 100. As an example, the vehicle control module 102 may operate in a fully or partially autonomous mode and may control the propulsion system 110, a brake system 176, and a steering system 178. The steering system 178 includes a steering wheel angle sensor 179. In an embodiment, the vehicle control module 102 controls operation of the systems 101, 110, 176 and 178 based on interactions with a vehicle occupant (or driver). The vehicle control module 102 may i) perform autonomous operations such as steering, braking, accelerating, etc., and/or ii) display and/or audibly playout messages, perform haptic operations via haptic devices 124, and/or output messages and/or corresponding signals via other output devices. One or more haptic devices 124 may be activated to signal to a driver to turn on a turn signal. For example, a haptic device 124 may be activated and provide a certain vibration pattern indicating to turn on a turn signal. The vibration pattern may be different than a vibration pattern used, for example, to warn the driver of a potential collision.

The vehicle 100 may further include the memory 180. The memory 180 may store sensor data 182, parameters 184, applications 186, algorithms 188, historical data 190, and other data 192. The parameters may include, for example, sensor parameters and data from the sensors 150. The applications 186 may include applications executed by the modules 102, 103, 107, 108.

Although the memory 180 and the vehicle control module 102 are shown as separate devices, the memory 180 and the vehicle control module 102 may be implemented as a single device. The memory 180 may also store historical data 190 and other data 192 such as driver driving patterns, driver turning patterns, driver changing lane patterns, driver turn signal activation patterns, other driver patterns, data collected by and/or generated by the ATS module 103, traffic data, navigation data, map data, GPS data, path data, sensor data, etc.

The vehicle control module 102 may control operation of the propulsion system 110, the video system including the display 120, the audio system 122, the haptic devices 124, the brake system 176, the steering system 178, a lighting system 194, a seating system 196, and/or other devices and systems according to parameters set by the modules 102, 103, 107, 108. The vehicle control module 102 may set at least some of the parameters based on signals received from the sensors 150. The lighting system 194 includes interior and exterior turn signal indicators 197. The turn signal indicators 197 include exterior lights used to indicate to other vehicles, pedestrians and cyclists that the vehicle 100 is turning or changing lanes. The turn signal indicators 199 further include interior lights and/or displays providing a visual indication that a turn signal is activated. This may include an illuminated arrow on an instrument cluster, an illuminated arrow on a display (e.g., center console display, head-up display, cluster display). Turn signal indicators and/or messages may also or alternatively be provided audibly and/or haptically via, for example, the audio system 122 and haptic devices 124. Turn signals may be provided via side and/or rearview mirrors. The turn signal indicators referred to herein may be manually activated via a turn signal level included in the turn signal levers and actuators 199. In an embodiment, the ATS module 103 may automatically actuate turn signal levers via corresponding actuators when automatically turning on turn signals. This allows a driver to manually move a turn signal lever to an off state when manually turning off a turn signal that was automatically activated. The driver may deactivate a turn signal automatically activated using other methods such as by pushing a button on a display, a center console, a dashboard, etc.

The vehicle control module 102 may receive power from the power sources 105, which may be provided to the propulsion system 110, the brake system 176, the steering system 178, the lighting system 194, the seating system 196, etc. Power supplied to the motors 132, the brake system 176, the steering system 178, the lighting system 194, the seating system 196, and/or actuators thereof may be controlled by the vehicle control module 102 to, for example, adjust: motor speed, torque, and/or acceleration; braking pressure; steering wheel angle; pedal position; state of haptic devices 124; etc. This control may be based on the outputs of the sensors 150, the navigation module 114, the GPS and GNSS receiver 116 and the data and information stored in the memory 180.

The vehicle control module 102 and/or the ATS module 103 may determine various parameters including vehicle speeds and accelerations, yaw rate, inertial momentum, wheel angles, steering wheel angle, a gear state, an accelerator position, a brake pedal position, and/or other information. The modules 102, 103 may further determine lane boundaries, lane locations, road locations, turn locations, speed limits, object locations, environmental conditions, etc.

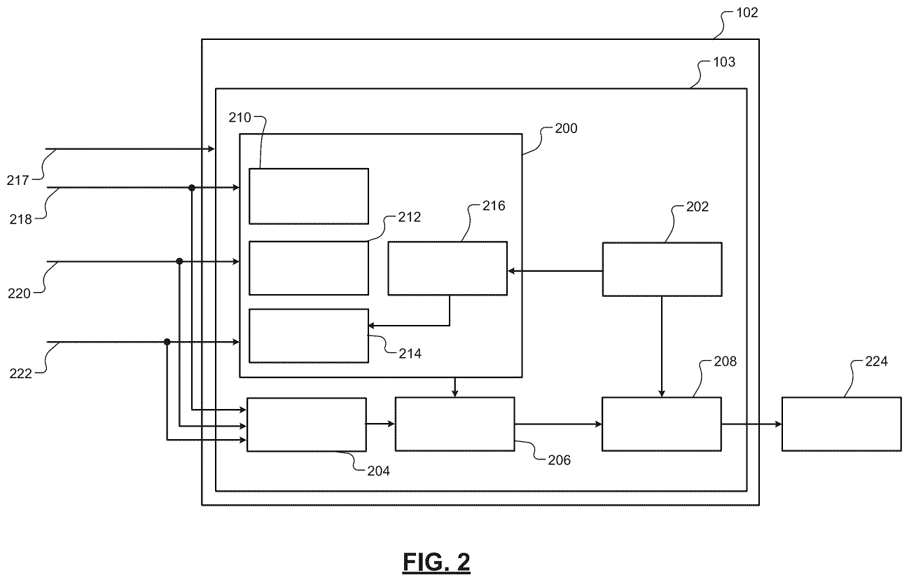

FIG. 2 shows the vehicle control module 102 and ATS module 103. The ATS module 103 includes an adaptive maneuver prediction module 200, a driver signal validation module 202, a confidence module 204, an activation decision module 206, and a signal indication module 208. The adaptive maneuver prediction module 200 includes a forward motion propagation module 210, a probabilistic uncertainty module 212, a turn prediction module 214, and a prediction error module 216.

The ATS module 103 may receive driver data 217 from sensors monitoring and/or detecting driver behavior and/or inputs. The ATS module 103 tracks, monitors and/or detects occupant head positions, eye movements, directions, and positions, gestures, body positioning, occupant speech, etc. and provides this information to any of the modules 200, 202, 206, 208. Gestures may include hand waves, finger swipes, finger taps, finger pointing, head nodding, arm movement, etc. Gestures may be provided on a display, on a steering wheel, on a center counsel, on an armrest, on another vehicle component, on a gear (or transmission) shifter, and/or without touching a vehicle component. The ATS module 103 may receive raw data streams the interior sensors, which are in the internal cabin of the host vehicle. This information is provided for extraction of driver related information. The extracted information includes gaze patterns and gaze directions determined based on the raw data streams from the interior sensors.

The modules 210, 212, 214 receive, access and/or obtain host vehicle data 218, environmental data 220, and historical data 222. The host vehicle data 218 includes vehicle sensor data from any of the sensors referred to herein. The host vehicle data 218 includes vehicle velocities, accelerations, yaw rate, steering wheel angle, inertial momentum, etc. The environmental data 220 includes any environmental data referred to herein including map data, lane markings, road types, object detection, weather information, navigation data etc. The historical data 222 includes any of the historical data referred to herein including driver driving patterns, and driver turn signal activation patterns including driver turn signal usage and lack of use, turn signal activation timing, etc. The historical data 222 may include, for example, indications of typical destinations of the driver, typical stops of the driver, typical turns, typical driving speeds, typical likes and dislikes of the driver, etc. The ATS module 103 may receive data and information from the navigation module 114 and the sensors 150 of FIG. 1, and/or other devices and sensors, such as information from a wireless network, information from nearby vehicles, information from a back office, etc.

The forward motion propagation module 210 based on the obtained data determines and predicts a path of the host vehicle. The forward motion propagation module implements a systematic model to predict vehicle motion using current and historic vehicle motion and path data. The probabilistic uncertainty module 212, based on the obtained data and the output of the forward motion propagation module 210, determines probabilistic uncertainty prediction values for future maneuver operations of the host vehicle. The probabilistic uncertainty module 212 implements an uncertainty model to make a prediction uncertainty estimate. The uncertainty model utilizes the model uncertainty, input uncertainty, and environmental uncertainties to effectively predict an uncertainty along the predicted path.

The turn prediction module 214, based on the obtained data, outputs of the probabilistic uncertainty module 212 and the prediction error module 216 including the predicted uncertainty (or probabilistic uncertainty prediction values) and a prediction model, detects and/or predicts upcoming turns and lane changes of the host vehicle. The prediction error module 216 calculated prediction error and corrects (or updates) the prediction model. The prediction error is used to correct the prediction model for future predictions. Equations 1-2 may be used to predict whether a left turn (or a change to a lane left of a current lane) or a right turn (or a change to a lane right of a current lane) is to be performed, where: H&S_{L} and H&S_{R} refer to obtained historical and statistical data for left and right turns; MP_{L} and MP_{R} represent the events that the driver makes left and right turns based on sensory data and related predictive logic; P(H&S_{L}|MP_{L}) refers to the probability of a left turn given the historical and statistical data for left turns; P(H&S_{R}|MP_{R}) refers to the probability of a right turn given the historical and statistical data for right turns; P(H&S_{L}) and P(H&S_{R}) represent the probabilities of the host vehicle turning left and right based on historical and statistical learning data; P(MP_{L}) and P(MP_{R}) represent the probabilities of the host vehicle turning left and right based on sensory data; P(MP_{L}|H&S_{L}) represents the conditional probability of the driver intending to make a left turn given that the driver the statistical data suggests that the driver is making a left turn; and P(MP_{R}|H&S_{R}) represents the conditional probability of the driver intending to make a right turn given that the driver the statistical data suggests that the driver is making a right turn. The above-stated parameters are applicable to both turns and lane changes.

$$P ( H \& {S}_{L} \vert {MP}_{L} ) = \frac{P ( {MP}_{L} \vert H \& {S}_{L} ) \cdot P ( H \& {S}_{L} )}{P ( {MP}_{L} )} \qquad ( 1 )$$

$$P ( H \& {S}_{R} \vert {MP}_{R} ) = \frac{P ( {MP}_{R} \vert H \& {S}_{R} ) \cdot P ( H \& {S}_{R} )}{P ( {MP}_{R} )} \qquad ( 2 )$$

The prediction may also be based on P(MP_{L}|H&S_{R}) and P(MP_{R}|H&S_{L}), where P(MP_{L}|H&S_{R}) represents the conditional probability of the driver intending to make a left turn given that the driver the statistical data suggests that the driver is making a right turn, and P(MP_{R}|H&S_{L}) represents the conditional probability of the driver intending to make a right turn given that the driver the statistical data suggests that the driver is making a left turn.

After calculating posterior probabilities, the predicted behavior may be determined as follows. If P(H&S_{L}|MP_{L}) is greater than P₀, then a left turn (or change to a left lane) is predicted. If P(H&S_{R}|MP_{R}) is greater than P₀, then a right turn (or change to a right lane) is predicted. P₀ may be set to a predetermined percentage. In an embodiment, P₀ is adjustable by a driver and/or user (or operator) of the ATS system. In an embodiment, a probability less than or equal to 50% is deemed a low probability, a probability greater than 50% and less than 90% is deemed a medium probability, and a probability greater than or equal to 90% is deemed a high probability. P₀ may be set between 50% and 90%. The higher that P₀ is set, the less sensitive the ATS system is to automatically activate a turn signal indicator.

The driver signal validation module 202 determines whether a prediction made by the ATS module 103 matches a driver manual turn signal activation or lack thereof. The driver signal validation module 202 determines whether a detected and/or predicted turn matches an activated turn signal indicator. For example, if the driver manually activates a left turn signal indicator and the ATS module 103 determines that the host vehicle is to make a right turn or move to a right lane, then the activated turn signal indicator does not match the predicted turn (or lane change). The driver signal validation module 202 provides feedback to the prediction error module 216 indicating whether the driver manually activated a turn signal. The driver signal validation module 202 indicates when the driver has not activated a turn signal indicator to the signal indication module 208.

The prediction error module 216 may determine a prediction error when the driver has manually turned on a turn signal indicator, as determined by the driver signal validation module 202. The prediction error module 216 may calculate a prediction error value. The prediction error value may be a value between 0 and 1 indicating a likelihood that the prediction was accurate. If the calculated prediction error value is above a predetermined threshold, then the prediction error module 216 may correct or update the prediction model used by the turn prediction module 214. The prediction error module 216 may implement a neural network and a machine learning algorithm and continue to learn when it is appropriate to activate turn signal indicators. The prediction model is updated based on driver behavior using a feedback loop.

The confidence module 204 determines a confidence level related to an awareness of the vehicle control module 102 and/or ATS module 103 in an environment of the host vehicle. The confidence level may be a value between 0 and 1 and indicate how confident the vehicle control module 102 and/or the ATS module 103 is in the detected state of the environment around the vehicle including detected objects, lane markings, road types, road locations, turn locations, sign locations, etc. The confidence module 204 performs gain scheduling of parameters in the confidence calculation based on prior expert knowledge of the control system of the vehicle and interaction with the environment.

The activation decision module 206 determines whether a turn signal indicator should be automatically activated (or triggered). This is based on data provided by modules 214 and 204 including the turn prediction of the turn prediction module 214 and the confidence level of the environment.

The signal indication module 208 activates, refrains from activating, and/or deactivates one or more turn signal indicators based on outputs of the modules 202, 206 including whether the prediction made by the turn prediction module 214 matches a manual turn signal activation by a driver and whether a turn signal should be automatically activated. The signal indication module 208 may activate one or more turn signal indicators when automatic activation is appropriate. In an embodiment, when an incorrect turn signal has been accidentally activated by, for example, the driver, the signal indication module 208 may deactivate the activated (or first) turn signal indicator and activate the correct (or second) turn signal indicator. In another embodiment, one of the modules 103, 202, 208 asks the driver whether the first turn signal indicator can be deactivated and receives approval from the driver prior to turning on the second turn signal indicator. For example, the module may message the driver indicating that the incorrect turn signal has or may have been activated and wait for a response from the driver.

FIG. 3 shows an example ATS method. The following operations may be iteratively performed.

At 300, the adaptive maneuver prediction module 200 collects sensor data as described above. At 302, the adaptive maneuver prediction module 200 collects environmental data as described above. At 304, the adaptive maneuver prediction module 200 collects historical data as described above. Operations 300, 302, 304 may be performed concurrently.

At 306, the forward motion propagation module 210 determines and predicts a path of the host vehicle. At 308, the probabilistic uncertainty module 212 determines a probabilistic uncertainty prediction value for a future maneuver of the host vehicle.

At 310, the turn prediction module 214 predicts whether the host vehicle is to make a turn or change lanes based on the probabilistic uncertainty prediction value. This includes making a turn or lane change prediction as described above.

At 312, the activation decision module 206, based on the turn or lane change prediction, determines i) whether one or more turn signal indicators should be activated, and ii) which one or more turn signal indicators should be activated.

At 314, the driver signal validation module 202 determines whether the driver has manually triggered activation of a turn signal indicator. If no, operation 316 may be performed, otherwise operation 328 and 334 may be performed.

At 316, the ATS module 103 determines whether operation in the teen mode or the fleet mode has been enabled. If yes, operation 318 may be performed, otherwise operation 324 may be performed.

At 318, the ATS module 103 may determine whether ATS operation is enabled. If yes, operation 320 may be performed, otherwise the method may end.

At 320, the activation decision module 206 may determine whether conditions are appropriate for automatic activation of a turn signal indicator. This may include determining whether the vehicle speed is above a predetermined speed (e.g., 10 mph), determining whether the driver has not manually activated a turn signal indicator, and/or whether one or more other conditions are satisfied. If the conditions are appropriate, operation 322 may be performed, otherwise operation 326 may be performed.

At 322, the signal indication module 208 activates one or more turn signals for the predicted turn or lane change direction. This is done automatically and thus without driver intervention. This may include illuminating one or more turn signals differently than when manually activated and/or audibly playing out a different click-clack (or audible) pattern than when manually activated. This also include displaying a message such as “Auto Turn Signal” to indicate that the turn signal indicator was automatically activated.

At 324, the ATS module 103 determines whether the driver triggered an override to disable automatic activation of turn signal indicators. As an example, an override button may be pressed on the steering wheel or elsewhere. As another example, the driver prior to a current driving event may have disabled automatic activation via a software screen on a display of the host vehicle. When an override has been triggered, an override flag may be set in memory indicating that the driver has disengaged automatic turn signal indication. If no, operation 320 may be performed, otherwise operation 326 may be performed.

At 326, the signal indication module 208 refrains from activating a turn signal indicator. In an embodiment, no turn signal indicator is automatically activated. The method may end subsequent to operation 326.

At 328, the driver signal validation module 202 determines whether the predicted turn matches the driver selected turn signal (or driver manually activated turn signal indicator). Is yes, operation 330 may be performed, otherwise operation 332 may be performed.

At 330, the signal indication module 208 maintains current turn signal activation. The method may end subsequent to operation 330.

At 332, the driver signal validation module 202 indicates to the driver that an incorrect turn signal may have been selected by the driver (or the driver may have activated the wrong turn signal indicator). This may be done audibly, via a display, or haptically. The driver signal validation module 202 generates a message and/or signal to indicate the wrong selection to the driver. The method may end subsequent to operation 332.

At 334, the prediction error module 216 calculates a prediction error as described above. At 336, the prediction error module 216 may determine whether the prediction error is greater than a predetermined threshold. If yes, operation 338 is performed, otherwise the method may end. At 338, the prediction error module 216 updates the prediction model to account for the incorrect prediction. The method may end subsequent to operation 338.

The above-described operations are meant to be illustrative examples. The operations may be performed sequentially, synchronously, simultaneously, continuously, during overlapping time periods or in a different order depending upon the application. Also, any of the operations may not be performed or skipped depending on the implementation and/or sequence of events.

FIG. 4 shows an overhead view of a host vehicle 400 that is to make a left turn and operating according to the principles described herein. The vehicle 400 may be configured similarly as the vehicle 100 of FIG. 1. The driver is driving along a linear path 402 and is to make a left turn. An oncoming vehicle 404 is present. In this example, the driver of the host vehicle 400 forgets to turn on a left turn signal indicator. The ATS system of the vehicle 400 predicts that the driver is to make a left turn and automatically turns on the left turn signal indicator to signal to the oncoming vehicle 404 that the vehicle 400 is to make a left turn.

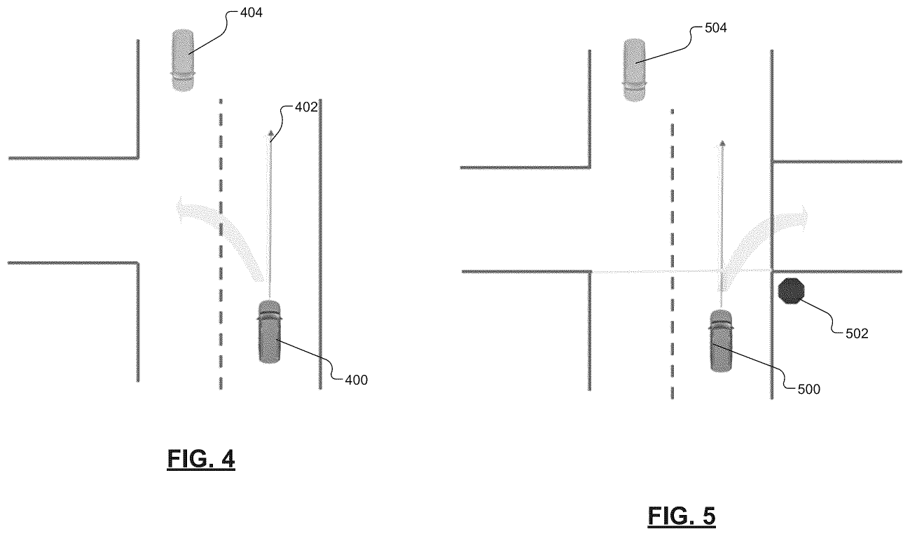

FIG. 5 shows an overhead view of a host vehicle 500 before a stop sign 502 and to make a right turn and operating according to the principles described herein. The vehicle 500 may be configured similarly as the vehicle 100 of FIG. 1. An oncoming vehicle 504 is present. In this example, the driver of the host vehicle 500 forgets to turn on a right turn signal indicator. The ATS system of the vehicle 500 predicts that the driver is to make a right turn and automatically turns on the right turn signal indicator to signal to the oncoming vehicle 504 that the vehicle 500 is to make a left turn. The ATS system may predict the driver's intent as soon as the host vehicle 500 is stationary and steering of the vehicle is moved in a direction of the right turn.

FIG. 6 shows an overhead view of a host vehicle 600 to make one of multiple possible right turns and operating according to the principles described herein. The vehicle 600 may be configured similarly as the vehicle 100 of FIG. 1. The driver of the host vehicle 600 forgets to turn on a turn signal indicator. This could cause the driver of the oncoming vehicle 602 to think that the host vehicle 600 is to continue following a linear path 604. The ATS system of the host vehicle 600 predicts that the driver is to make a right turn and automatically activates the right turn signal indicator to indicate to the oncoming vehicle that the host vehicle is to make a right turn.

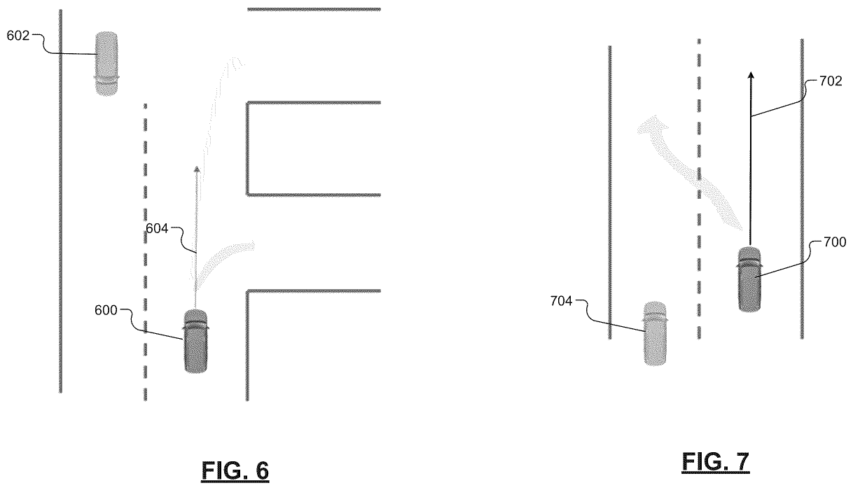

FIG. 7 shows an overhead view of a host vehicle 700 to change lanes and operating according to the principles described herein. The vehicle 700 may be configured similarly as the vehicle 100 of FIG. 1. The host vehicle 700 is initially driving along a linear path 702 and the driver decides to change lanes in front of a nearby vehicle 704. The driver forgets to turn on the left turn signal indicator and the ATS system of the host vehicle 700 predicts that the driver is to change lanes and automatically turns on the left turn signal indicator.

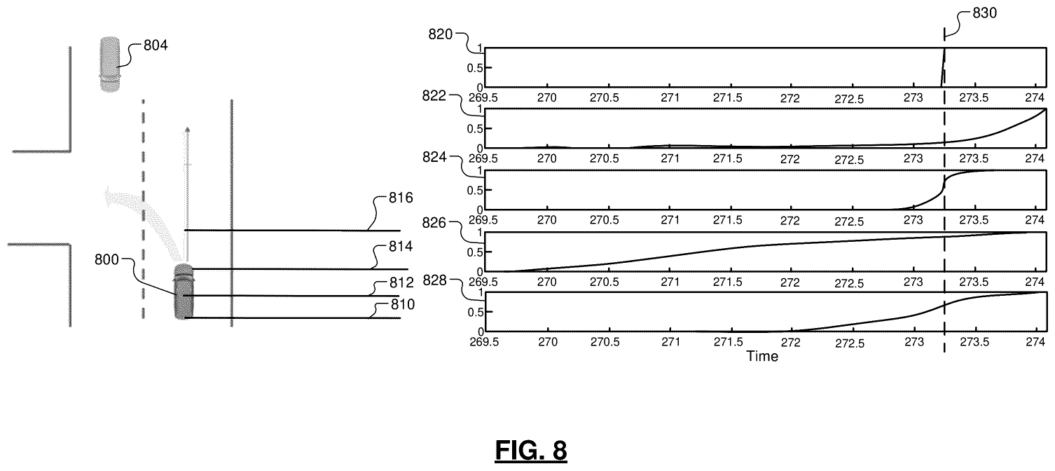

FIG. 8 shows i) an overhead view of a host vehicle 800 to make a left turn and operating according to the principles described herein, and ii) timing plots, illustrating quick automatic triggering of turn signal operation. The vehicle 800 may be configured similarly as the vehicle 100 of FIG. 1. The driver of the vehicle 800 intends to make a left turn. The ATS system of the vehicle 800 predicts that the driver is to make a left turn and automatically activates a turn signal indicator to indicate to the oncoming vehicle 804 that the vehicle 800 is to turn left. The timing of operations performed by the ATS system and driver are designated 810, 812, 814, 816. At the point in time associated with 810, the ATS system predicts that the driver intends to make a left turn. At the point in time associated with 812, the driver starts making the turn. At the point in time associated with 814, the ATS system (or adaptive maneuver module of the ATS system) predicts the turn and automatically turns on the left turn signal indicator. At the point in time associated with 816, the vehicle 800 is making the left turn.

The timing plots include a turn signal plot 820, a lateral offset plot 822, a probability plot 824, a vehicle velocity plot 826, and a road wheel angle plot 828. A dashed line 830 is shown to indicate when the left turn signal is activated (i.e., turned ON). In the example shown and at this point, the lateral offset is 35 centimeters and the probability of a left turn is greater than 70%. These values are provided only as examples for a particular situation, turn, and driver and can be different. The lateral offset plot 822 is indicative of when the vehicle 800 begins to make the left turn and refers to the position of the vehicle 800 relative to a center of the lane in which the vehicle 800 is located.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A turn signal indication system comprising:
at least one turn signal indicator;
an adaptive maneuver prediction module configured to predict that a host vehicle is to make a turn or change lanes;
an activation decision module configured to, based on the prediction, determine whether the host vehicle is to make a left turn, make a right turn, change to a left lane, or change to a right lane; and
a signal indication module configured to automatically activate the at least one turn signal indicator based on the determination of whether the host vehicle is to make a left turn, make a right turn, change to a left lane, or change to a right lane.

2. The turn signal indication system of claim 1, wherein the adaptive maneuver prediction module is configured to
determine a first probability value indicative of a probability of a left turn or a change to a left lane based on at least one of i) historical and statistical data for left turns and changes to left lanes, and ii) sensory data for left turns and changes to left lanes;
determine a second probability value indicative of a probability of a right turn or a change to a right lane based on at least one of i) historical and statistical data for right turns and changes to right lanes, and ii) sensory data for right turns and changes to right lanes;
predict the host vehicle is to make a left turn or change to a left lane based on the first probability value; and
predict the host vehicle is to make a right turn or change to a right lane based on the second probability value.

3. The turn signal indication system of claim 1, further comprising a turn signal module configured to determine whether to inhibit automatic turn signal activation based on whether a driver override flag has been set.

4. The turn signal indication system of claim 1, further comprising a turn signal module configured to adjust timing of automatic turn signal activation based on a received user input, wherein the received user input is at least one of indicative and directly related to an amount of time prior to a turn to activate the at least one turn signal indicator.

5. The turn signal indication system of claim 1, wherein the at least one turn signal indicator has a different color when automatically triggered than when manually triggered.

6. The turn signal indication system of claim 1, wherein the at least one turn signal indicator has a different audible pattern when automatically triggered than when manually triggered.

7. The turn signal indication system of claim 1, further comprising a turn signal module configured to determine a speed of the host vehicle and, based on the speed, to inhibit activation of the at least one turn signal indicator.

8. The turn signal indication system of claim 1, further comprising a driver signal validation module configured to detect manual triggering of the at least one turn signal indicator by a driver, and to determine whether the manually triggered at least one turn signal indicator matches the prediction,
wherein the signal indication module is configured to generate a message for the driver indicating to the driver that an incorrect turn signal indicator may have been selected.

9. The turn signal indication system of claim 1, further comprising a driver signal validation module configured to detect manual triggering of the at least one turn signal indicator by a driver, and to determine whether the manually triggered at least one turn signal indicator matches the prediction,
wherein the signal indication module is configured to maintain activation of the manually triggered at least one turn signal indicator in response to the manually triggered at least one turn signal indicator matching the prediction.

10. The turn signal indication system of claim 1, further comprising a prediction error module configured to calculate a prediction error value for the prediction, and to update a prediction model used to make the prediction based on the prediction error value.

11. The turn signal indication system of claim 10, further comprising a driver signal validation module configured to detect manual triggering of the at least one turn signal indicator by a driver, and to determine whether the manually triggered at least one turn signal indicator matches the prediction,
wherein the prediction error module is configured to calculate the prediction error value based on whether the manually triggered at least one turn signal indicator matches the prediction.

12. A method for automatically activating at least one turn signal indicator, the method comprising:
predicting that a host vehicle is to make a turn or change lanes;
based on the prediction, determining whether the host vehicle is to make a left turn, make a right turn, change to a left lane, or change to a right lane; and
automatically activating the at least one turn signal indicator based on the determination of whether the host vehicle is to make a left turn, make a right turn, change to a left lane, or change to a right lane.

13. The method of claim 12, further comprising:
determining a first probability value indicative of a probability of a left turn or a change to a left lane based on at least one of i) historical and statistical data for left turns and changes to left lanes, and ii) sensory data for left turns and changes to left lanes;
determining a second probability value indicative of a probability of a right turn or a change to a right lane based on at least one of i) historical and statistical data for right turns and changes to right lanes, and ii) sensory data for right turns and changes to right lanes;
predicting the host vehicle is to make a left turn or change to a left lane based on the first probability value; and
predicting the host vehicle is to make a right turn or change to a right lane based on the first probability value.

14. The method of claim 12, further comprising determining whether to inhibit automatic turn signal activation based on whether a driver override flag has been set.

15. The method of claim 12, further comprising adjusting timing of automatic turn signal activation based on a received user input, wherein the received user input is at least one of indicative and directly related to an amount of time prior to a turn to activate the at least one turn signal indicator.

16. The method of claim 12, wherein the at least one turn signal indicator has a different color when automatically triggered than when manually triggered.

17. The method of claim 12, wherein the at least one turn signal indicator has a different audible pattern when automatically triggered than when manually triggered.

18. The method of claim 12, further comprising determining a speed of the host vehicle and, based on the speed, inhibit activation of the at least one turn signal indicator.

19. The method of claim 12, further comprising:
detecting manual triggering of the at least one turn signal indicator by a driver;
determining whether the manually triggered at least one turn signal indicator matches the prediction;
generating a message for the driver indicating to the driver that an incorrect turn signal indicator may have been selected; and
maintaining activation of the manually triggered at least one turn signal indicator in response to the manually triggered at least one turn signal indicator matching the prediction.

20. The method of claim 12, further comprising:
calculating a prediction error value for the prediction, and update a prediction model used to make the prediction based on the prediction error value;
detecting manual triggering of the at least one turn signal indicator by a driver, and determine whether the manually triggered at least one turn signal indicator matches the prediction; and
calculating the prediction error value based on whether the manually triggered at least one turn signal indicator matches the prediction.
